(19) United States
(12) Patent Application Publication
(10) Pub. No.: US 2024/0353238 A1
(43) Pub. Date: Oct. 24, 2024

(54) WEAK MEASUREMENT BASED SYSTEMS AND DEVICES FOR QUANTUM METROLOGY

(71) Applicant: NVIDIA CORPORATION, Santa Clara, CA (US)

(72) Inventors: Hossein Seifoory, Toronto (CA); Elad Mentovich, Tel Aviv (IL); Juan Jose Vegas Olmos, Solroed Strand (DK)

(21) Appl. No.: 18/137,737

(22) Filed: Apr. 21, 2023

(51) Int. Cl. G01D 3/036

(52) U.S. Cl. CPC G01D 3/036

(57) ABSTRACT

Systems, devices, and methods are described herein that are employed in quantum metrology. An example quantum device includes a weak measurement module operably coupled with a quantum system. The weak measurement module is configured to apply one or more measurements to the quantum system and obtain information associated with the quantum system based on the one or more measurements. A strength of the one or more measurements by the weak measurement module is configured to prevent a wave function collapse associated with the quantum system. The quantum device further includes a data processing unit (DPU) operably coupled with the weak measurement module that performs one or more operations on the obtained information associated with the quantum system and provides improved time synchronization and networking features.

### TECHNOLOGICAL FIELD

Example embodiments of the present disclosure relate generally to quantum systems and, more particularly, to quantum devices that leverage weak measurements.

### BACKGROUND

Communication networks, computing systems, and the like are employed in a variety of applications in order to transmit data from one location to another and/or perform various operations. Quantum systems leverage the laws of quantum mechanics (e.g., superposition, entanglement, etc.) to provide the transmission of information between nodes in a network, to perform complex processes, and/or the like. Through applied effort, ingenuity, and innovation, various deficiencies and problems associated with quantum devices and systems have been solved by developing solutions that are configured in accordance with the embodiments of the present disclosure, many examples of which are described in detail herein.

### BRIEF SUMMARY

Weak measurement based systems, devices, and methods are described herein that are employed in quantum metrology. An example quantum device may include a weak measurement module operably coupled with a quantum system. The weak measurement module may be configured to apply one or more measurements to the quantum system and obtain information associated with the quantum system based on the one or more measurements.

In some embodiments, a strength of the one or more measurements by the weak measurement module may be configured to prevent a wave function collapse associated with the quantum system.

In some embodiments, the quantum device may further include a data processing unit (DPU) operably coupled with the weak measurement module and configured to perform one or more operations on the obtained information associated with the quantum system. The one or more operations may be performed local to the quantum device by the DPU.

In some further embodiments, the one or more operations may be associated with one or more synchronization operations.

Additionally or alternatively, in some further embodiments, the one or more operations may be associated with one or more error correction operations.

In some further embodiments, the DPU may be operably coupled with a classical communication channel.

In some still further embodiments, the DPU may be configured to generate transmissions to a central control unit and associated network operably coupled with the quantum device via the classical communication channel.

In some still further embodiments, the DPU may be configured to generate transmissions to another quantum device operably coupled with the quantum device via the classical communication channel.

In some embodiments, the weak measurement module may be operably coupled with another quantum device via a quantum communication channel.

In some further embodiments, the another quantum device may be configured to apply one or more measurements to the quantum system.

An example distributed quantum system may include a central control unit and a first quantum device. The first quantum device may include a first weak measurement module operably coupled with a quantum system. The first weak measurement module may be configured to apply one or more first measurements to the quantum system and obtain information associated with the quantum system based on the one or more first measurements. The distributed quantum system may further include a second quantum device including a second weak measurement module operably coupled with the quantum system. The second weak measurement module may be configured to apply one or more second measurements to the quantum system obtain information associated with the quantum system based on the one or more second measurements. A strength of the one or more first measurements by the first weak measurement module and/or the second weak measurement module may be configured to prevent a wave function collapse associated with the quantum system.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an example quantum device operably coupled with a quantum system in accordance with one or more embodiments of the present disclosure;

FIG. 2 illustrates an example DPU for use by the quantum devices described herein in accordance with one or more embodiments of the present disclosure;

FIG. 3 illustrates example circuitry components for use by the example DPU of FIG. 2 in accordance with one or more embodiments of the present disclosure;

FIG. 4 illustrates an example distributed quantum system arrangement with multiple quantum devices associated with the same quantum system under study in accordance with one or more embodiments of the present disclosure; and

FIG. 5 illustrates an example quantum system arrangement with multiple quantum systems under study in accordance with one or more embodiments of the present disclosure.

### DETAILED DESCRIPTION

### Overview

Quantum computers represent an emerging type of computer that leverage the laws of quantum mechanics, such as superposition and entanglement, to solve certain computing problems exponentially faster than classical computers (e.g., transistor-based computers). In a quantum computer, the basic units of information are quantum bits (qubits), which are the quantum analog of binary bits in a classical computer. In general, the processing power of a quantum computer may be increased by increasing the number of qubits on the quantum computer. Quantum communication systems also leverage these laws of quantum mechanics (e.g., superposition, entanglement, etc.) to facilitate the transmission of information between two (2) communicating parties and/or separate quantum processors, modules, etc.

As described above, in quantum information theory, a qubit is the basic unit of quantum information and may be formed as a superposition of zero (0) and one (1), unlike classical bits that may only exist as either zero (0) or one (1). Qubits, however, are often fragile and may be impacted by loss or any interaction with the environment. In particular, a qubit may have an associated coherence time that determines how long the quantum state survives before losing information. The length of the coherence time may be determined by the type of the qubit (e.g., photonic qubits, superconducting qubits, trapped ions, etc.), and/or the qubit's interaction with the environment. Furthermore, loss may reduce the coherence time of a qubit and, therefore, limits the available time for an operation to be performed on the qubit. Although any two-state system may be viewed as a qubit, there are other quantum systems for which the possible outcome of a measurement may not be summarized in only two possible states, and these systems are similarly impacted by coherence time.

Thus, to address these and/or other issues, the embodiments of the present disclosure leverage the data transfer and processing speed provided by DPUs and the information obtained via weak measurements to enable quantum metrology at the quantum device level. The high processing capabilities of the DPU enable these devices and systems to add useful information to the data obtained through the weak measurement. Furthermore, the weak measurements allow the quantum devices and systems to obtain useful information associated with the quantum system under study without causing a wave function collapse associated with the quantum system. In some embodiments, each quantum device may be associated with a respective quantum system and DPU. In other embodiments, multiple quantum devices, each employing respective weak measurement devices and DPUs may measure the same quantum system. The information obtained by these node-level (e.g., quantum device level) weak measurement may be used for synchronization operations, error correction operations, and/or the like. In doing so, the embodiments of the present disclosure may provide DPU and weak measurement assisted quantum metrology implementations which were historically unavailable.

Embodiments of the present disclosure now will be described more fully hereinafter with reference to the accompanying drawings in which some but not all embodiments are shown. Indeed, the present disclosure may be embodied in many different forms and should not be construed as limited to the embodiments set forth herein; rather, these embodiments are provided so that this disclosure will satisfy applicable legal requirements. Like numbers refer to like elements throughout. Furthermore, as would be evident to one of ordinary skill in the art in light of the present disclosure, the terms “substantially” and “approximately” indicate that the referenced element or associated description is accurate to within applicable engineering tolerances.

### Example Quantum Devices

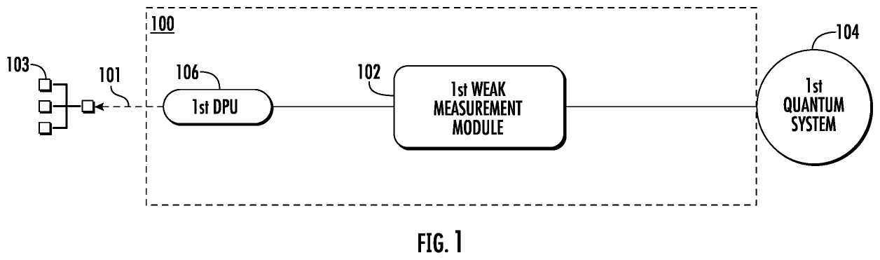

With reference to FIG. 1, an example quantum device 100 (e.g., first quantum device 100) is illustrated. As shown, the first quantum device 100 may include a first weak measurement module 102 that is operably coupled with a first quantum system 104. The first quantum system 104 may refer to any system, device, collection of devices, etc. that at least partially employs quantum physics, quantum particles, etc. in its operation. By way of a non-limiting example, the first quantum system 104 may include a quantum communication system, quantum channel, or the like in which photons are the object in the quantum communication system within which data is encoded. Although described in this example embodiment with reference to qubits transmitted via a quantum communication channel, the present disclosure contemplates that the techniques described herein may be applicable to quantum particles of any type or information encoded in any way for transmission via quantum communication channels.

In quantum systems, such as the first quantum system 104, the quantum basis may refer to the way in which data is encoded in an example photon where the data is the value of the encoded information. This encoding may be accomplished via sets of orthogonal quantum states, including, but not limited to, pairs of photonic polarization states. The pairs of photonic polarization states may include, for example, the rectilinear, diagonal, and circular photonic polarization states. The rectilinear basis may refer to the pair of rectilinear photonic polarization states including the horizontal photon polarization state |0 [symbol] and the vertical photon polarization state |1 [symbol] . The diagonal basis may refer to the pair of diagonal and anti-diagonal photonic polarization states at 45 135 degrees, respectively. The circular basis may refer to the pair of circular photonic polarization states include the left circular photon polarization state |L [symbol] and the right circular photon polarization state |R [symbol] . The state may refer to a basic unit of quantum information comprising a two-level quantum mechanical system, such as the polarization of a single photon (e.g., a photon encoded using a quantum basis as described above). In such an example embodiment, the quantum communication system (e.g., first quantum system 104) may use the quantum state, quantum basis, etc., among other attributes of the quantum particles, to transmit data.

By way of an additional example, the first quantum system 104 may refer to a quantum computer or quantum computing system. In such an example embodiment, the quantum computing system (e.g., first quantum system 104) may rely upon the quantum state, quantum basis, etc., among other attributes of the quantum particles, to perform one or more operations, processes, computations, and/or the like. As would be evident to one of ordinary skill in the art in light of the present disclosure, the example quantum computer or quantum computing system (e.g., first quantum system 104) may be configured to perform any computational problem associated with classical computers. Said differently, quantum algorithms employed by the example quantum computer (e.g., first quantum system 104) for certain computational problems may have significantly lower time requirements than corresponding classical algorithms. Although described herein with reference to an example quantum communication systems and quantum computing systems, the present disclosure contemplates that the first quantum system 104 may refer to any system, device, collection of devices, etc. that at least partially rely upon quantum mechanical phenomena, quantum physics, quantum particles, etc. in its operation.

With continued reference to FIG. 1, the first quantum system 104 may be operably coupled with the first weak measurement module 102. By way of example, in instances in which the first quantum system 104 is a quantum communication system, the first weak measurement module 102 may be operably or communicably coupled with a quantum communication channel configured to transmit information encoded in one or more qubits. Additionally or alternatively, the first weak measurement module 102 may be directly coupled with the first quantum system 104, such as in instances in which the first quantum system 104 is a quantum computer. The present disclosure contemplates that the first weak measurement module 102 may be coupled with the first quantum system 104 (e.g., the quantum system under study) by any mechanism, structure, etc. so as to apply measurements to the first quantum system 104 as described hereafter.

The first weak measurement module 102 may be configured to apply one or more measurements to the first quantum system 104 and may include any components used for applying such a measurement. The measurement may refer to a manipulation of qubits used by the first quantum system 104 to yield information regarding the state of each qubit. An example measurement as described herein may be configured to ascertain or determine any parameter, attribute, etc. of the first quantum system 104 and may further be configured to determine, infer, or detect any information, content, and/or data transmitted or used by the first quantum system 104. The measurements of the first weak measurement module 102 may be associated with a strength or magnitude that may refer to the physical coupling (e.g., mutual interaction) between the first weak measurement module 102 and the first quantum system 104. The strength or magnitude may be used with reference to example measurements as described above and may further be variable (e.g., variable strength measurements). As would be evident to one of ordinary skill in the art in light of the present disclosure, the measurement by the first weak measurement module 102 may at least partially disturb the quantum particles of the first quantum system 104, and the strength of the measurement may be directly related to this disturbance. Said differently, as the strength of the applied measurement increases, the information obtained by the first weak measurement module 102 may increase, but the disturbance to the first quantum system 104 may similarly increase. In some instances, the strength or magnitude of the measurement applied by weak measurement modules may be such that (e.g., sufficiently strong) the wave function associated with the quantum system collapses.

In order to minimize the disturbance to the first quantum system 104, the first weak measurement module 102 of the first quantum device 100 may apply measurements having a strength or magnitude that may be referred to as weak (e.g., a weak measurement) in that the strength of the measurement is such that the first weak measurement module 102 obtains less information (e.g., relative a strong measurement) about the underlying data but also disturbs the first quantum system 104 less (e.g., relative a strong measurement). In particular, the term weak measurement may also encompass any variable-strength measurement that does not lead to a wave function collapse of the first quantum system 104. In other words, the weak measurement applied by the first weak measurement module 102 referred to hereinafter does not require a particular or defined strength or magnitude, but instead refer to any measurement or collection of measurements that do not necessarily result in collapse of the wave function of the measure signal and/or qubit. The present disclosure contemplates that the first weak measurement device 102 may employ weak measurements of any frequency, type, etc. based upon the quantum system under study (e.g., the first quantum system 104) and/or the intended application of the quantum device 100.

As described above, a qubit may have an associated coherence time that determines how long the quantum state survives before losing information. By way of example, the first quantum system 104 may have an associated coherence time window during which the quantum state of the first quantum system 104 may survive before losing information. Said differently, information associated with the first quantum system 104 that is obtained outside of the coherence time window associated with the first quantum system 104 may be incomplete, inaccurate, and/or the like due potential loss associated with the first quantum system 104 outside of the coherence time window. As such, the weak measurements applied by the first weak measurement module 102 of the first quantum system 104 may occur during the coherence tie window associated with the first quantum system 104 or otherwise be time-stamped so as to avoid or minimize the impact of loss on the information obtained from the first quantum system 104.

The first weak measurement module 102 may further be configured to obtain information associated with the first quantum system 104 based on the one or more weak measurements. As described above, the quantum basis may refer to the way in which data is encoded in an example photon where the data is the value of the encoded information. As such, in some embodiments, the information obtained by the first weak measurement module 102 associated with the first quantum system 104 may be indicative of the quantum basis of at least one of the quantum particles (e.g., photons or the like) leveraged by the first quantum system 104. By way of an additional example, the information obtained by the first weak measurement module 102 associated with the first quantum system 104 may be indicative of the polarization state of at least one of the quantum particles (e.g., photons or the like) leveraged by the first quantum system 104. Although described herein with reference quantum basis and polarization state as example information that may be obtained by the first weak measurement module 102, the present disclosure contemplates that any parameter, attribute, characteristic, etc. associated with the first quantum system 104 may be obtained by the first weak measurement module 102. Furthermore, in some embodiments, the obtained information may include or otherwise be indicative of the underlying data encoded by the quantum particles used by the first quantum system 104.

The data processing capabilities of the first DPU 106 described hereafter of the first quantum device 100 enable operations in quantum metrology at the device level which were historically unavailable. By way of a non-limiting example, the information obtained by the first weak measurement module 102 from the weak measurements applied to the first quantum system 104 may be used for one or more error correction operations, such as in instances in which the first quantum system 104 is associated with a quantum computer. As would be evident to one of ordinary skill in the art in light of the present disclosure, quantum error correction may refer to operations used to ensure the validity of quantum information or otherwise protect quantum information from errors (e.g., decoherence, quantum noise, etc.) that may result from synchronization issues, weak measurement issues, and/or the like. Unlike classical error correction in which redundancy (e.g., repetition code) may be used to store information, the copying of quantum information is believed to be limited (e.g., the no-cloning theorem). As such, the operations performed by the first DPU 106 at the quantum device 100 level may be associated with quantum error correction operations and methodologies based on a variety of diverse approaches (e.g., syndrome measurements, redundancy, repetition codes, qubit expansion under Shor's error correction algorithm, and/or any other error correction method that may leverage the storage and/or processing provided by the first DPU 106) so as to minimize or prevent errors associated with the information obtained from the first quantum system 104.

By way of an additional, non-limiting example, the information obtained by the first weak measurement module 102 from the weak measurements applied to the first quantum system 104 may be used for one or more synchronization operations. As would be evident to one of ordinary skill in the art in light of the present disclosure, synchronization may refer to the ability to coordinate the clock status in different locations of a system, which may be particularly relevant in the embodiments of the present disclosure in order to effectively represent a weak measurement value. In some embodiments, the first quantum device 100 may rely on or otherwise leverage a primary reference clock, based in either a global navigation satellite system or any other global time distribution system, and boundary clocks relaying clock information on a network segment. A containerized approach for time distribution may be conducted, in which containers containing time information are distributed, and hypervisors at the first DPU 106 retrieve the clock information and tune its bounded clock accordingly.

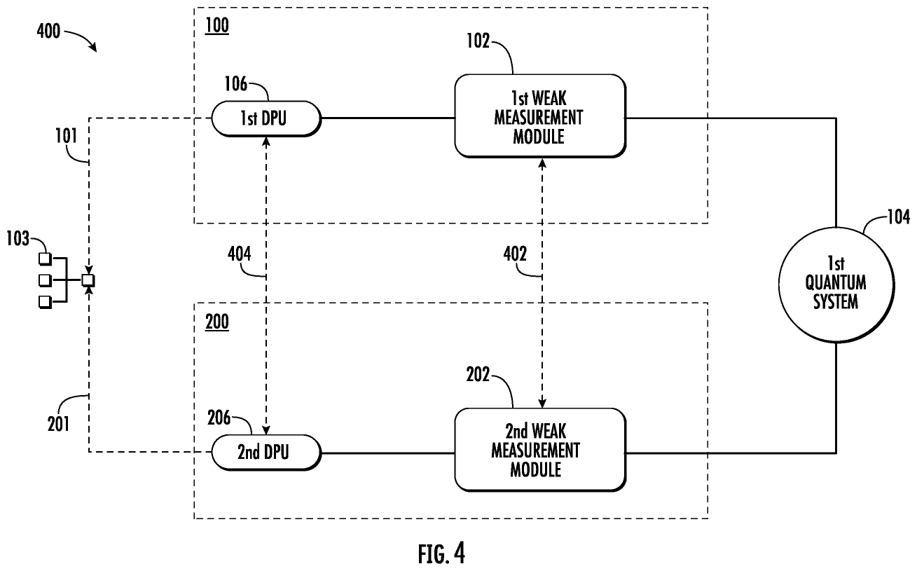

As described hereafter with reference to FIG. 4, for example, in some embodiments the first quantum system 104 may be under study by or otherwise measured by multiple quantum devices. In such an embodiment, the multiple quantum devices may, for example, perform measurements that are interdependent in that the operations performed by one quantum device implicate the measurements performed by another device. In such an example, the operations that are performed by the DPUs of these quantum devices may be configured to synchronize or otherwise stage the timing at which measurements are applied by the multiple quantum devices. Although described herein with reference to quantum error correction and synchronization operations, the present disclosure contemplates that the quantum devices of the present disclosure may perform operations of any type based upon the nature of the quantum system under study and/or the intended application of the respective quantum device.

### Example DPU Implementations

The first quantum device 100 may further include a first data processing unit (DPU) 106 operably coupled with the first weak measurement module 102. The high processing capabilities of the DPU enables the first quantum device 100 to add this useful information to the data obtained by the first weak measurement module 102. The first DPU 106 may be configured to generate various transmissions (e.g., data packets or the like) comprising quantum data based upon at least one of the one or more weak measurements by the first weak measurement module 102 or the obtained information associated with the first quantum system 104. As would be evident to one of ordinary skill in the art in light of the present disclosure, the first DPU 106 may be configured to perform one or more operations on the obtained information associated with the first quantum system 104 during a coherence time window associated with the first quantum system 104.

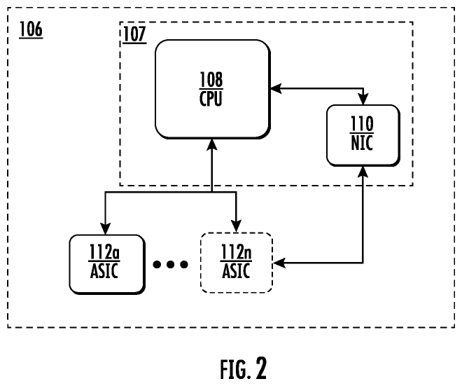

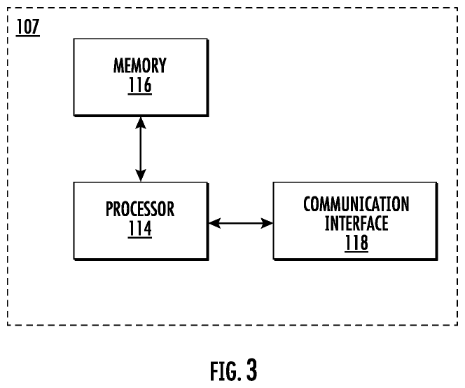

As shown in FIG. 2, the first DPU 106 may include one or more application-specific integrated circuits (ASICs) 112a-n (e.g., acceleration engines) that are communicably coupled with the processing portion 107 of the first DPU 106. As shown, the processing portion 107 of the first DPU 106 may include a high-performance, software-programmable central processing unit (CPU) 108 that is communicably coupled with a network interface controller (NIC) 110. As described hereinafter with reference to the circuitry components of FIG. 3, the CPU 108 and the NIC 110 may be configured to generate transmissions (e.g., data packets or the like) comprising quantum data indicative of the information obtained via weak measurements applied by the first weak measurement module 102. Unlike conventional systems in which a centralized control unit or processor may directly receive data from a measurement device, the first DPU 106 of the present disclosure may operate to perform preprocessing steps (e.g., error correction, synchronization, or the like) prior to transmission to a centralized control device (e.g., a preprocessing operation) or otherwise local to the first quantum device 100 by the first DPU 106. Additionally or alternatively, in some embodiments, the first quantum device 100 may be directly coupled with another quantum device (e.g., second quantum device 200 in FIG. 4) such that transmissions may occur between quantum devices (e.g., via quantum communication channels, classical communication channels, etc.)

With reference to FIG. 3, example circuitry components of the processing portion of the first DPU 106 (e.g., the CPU 108 and/or the NIC 110) are illustrated that may, alone or in combination with any of the components described herein, be configured to perform the operations. As shown, the first DPU 106 may include, be associated with or be in communication with processor 114, a memory 116, and a communication interface 118. The processor 114 may be in communication with the memory 116 via a bus for passing information among components of the first DPU 106. The memory 116 may be non-transitory and may include, for example, one or more volatile and/or non-volatile memories. In other words, for example, the memory 116 may be an electronic storage device (e.g., a computer readable storage medium) comprising gates configured to store data (e.g., bits) that may be retrievable by a machine (e.g., a computing device like the processing circuitry). The memory 116 may be configured to store information, data, content, applications, instructions, or the like for enabling the apparatus to carry out various functions in accordance with an example embodiment of the present disclosure. For example, the memory 116 could be configured to buffer input data for processing by the processor 114. Additionally or alternatively, the memory 116 could be configured to store instructions for execution by the processor 114.

The first DPU 106 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 114 may be embodied in a number of different ways. For example, the processor 114 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 114 may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 114 may be configured to execute instructions stored in the memory 116 or otherwise accessible to the processor 114. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 114 is embodied as an executor of instructions, the instructions may specifically configure the processor to perform the algorithms and/or operations described herein when the instructions are executed. However, in some cases, the processor 114 may be a processor of a specific device configured to employ an embodiment of the present disclosure by further configuration of the processing circuitry by instructions for performing the algorithms and/or operations described herein. The processor 114 may include, among other things, a clock, an arithmetic logic unit (ALU) and logic gates configured to support operation of the processing circuitry.

The communication interface 118 may be any means such as a device or circuitry embodied in either hardware or a combination of hardware and software that is configured to receive and/or transmit data, including media content in the form of video or image files, one or more audio tracks or the like. In this regard, the communication interface 118 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. By way of a non-limiting example, the communication interface 118 may include a host interface (e.g., PCIe or the like) and a network interface (e.g., Ethernet, InfiniBand®, or the like).

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the first DPU 106 may provide or supplement the functionality of particular circuitry.

Turning back to FIG. 1, the first quantum device 100 may be operably coupled with a first central control unit 103 via a first classical communication channel 101. The first central control unit 103 may be any classical device configured to process, analyze, etc. the data provided from the first quantum device 100. As such, the first central control unit 103 may refer to any collection of computing devices (e.g., CPUs, DPUs, graphics processing units (GPUs), etc.) configured to alone or collectively perform operations of data generated by quantum devices. In operation, the first DPU 106 may be configured to generate and provide transmissions (e.g., data packets or the like) to the central control unit 103 via the first classical communication channel 101. As would be evident to one of ordinary skill in the art in light of the present disclosure, the first classical communication channel 101 may refer to any medium through or by which data may be transmitted (e.g., optical fibers, free space, electrical wires, etc.). The first central control unit 103 may further refer to a network associated with the quantum devices, systems, etc. described herein. By way of example, the first DPU 106 of the first quantum device 100 may generate transmissions that are provided not only to the first central control unit 103 but also to any other device, collection of devices, etc. formed as part of a larger network that includes the first central control unit 103 and the first quantum device 100.

### Multi-Weak Measurement Module Implementations

With reference to FIG. 4, in some embodiments, at least another quantum device (e.g. a collection of quantum devices) may be associated with the same quantum system (e.g., the first quantum system 104) and configured to apply measurements to this quantum system. As shown in FIG. 4, for example, a quantum system arrangement 400 may include the first quantum device 100 described above with reference to FIGS. 1-3 and a second quantum device 200 operably coupled with the first quantum system 104. The second quantum device 200 may include a second weak measurement module 202 that may be configured to apply one or more measurements to the first quantum system 104 and may include any components used for applying such a measurement. As described above with reference to the first weak measurement module 102, an example measurement by the second weak measurement module 202 may be configured to ascertain or determine any parameter, attribute, etc. of the first quantum system 104 and may further be configured to determine, infer, or detect any information, content, and/or data transmitted or used by the first quantum system 104. The second weak measurement module 202 of the second quantum device 200 may apply measurements having a strength or magnitude that may be referred to as weak (e.g., a weak measurement) in that the strength of the measurement does not necessarily result in collapse of the wave function of the measure signal and/or qubit. The second weak measurement module 202 may be configured to obtain information associated with the first quantum system 104 based on the one or more measurements similar to the first weak measurement module 102 described above.

In some embodiments, the weak measurements applied to the first quantum system 104 by the first weak measurement module 102 and the second weak measurement module 202 may be substantially the same in type, frequency, magnitude, etc. In such an example embodiment, the multiple quantum devices 100, 200 measuring the first quantum system 104 may provide redundancy. In some embodiments, the measurements applied by the weak measurement modules 102, 200 and/or the information obtained by the weak measurement modules 102, 202 may differ. For example, the weak measurements applied by the first weak measurement module 102 may be associated with a first procedure or operation, and the weak measurements applied by the second weak measurement module 202 may be associated with a second procedure or operation. In order to provide communication between the weak measurement modules 102, 202, such as in instances in which the measurements by the modules 102, 202 are related or interdependent, the quantum system arrangement 400 may include a quantum communication channel 402 communicably coupling the first weak measurement module 102 and the second weak measurement module 202. For example, the quantum communication channel 402 may allow the transmission of quantum particles between the first weak measurement module 102 and the second weak measurement module 202.

With continued reference to FIG. 4, the second quantum device 200 may further include a second DPU 206. The second DPU 206 may be configured to perform substantially the same operations as the first DPU 106 and/or include the same circuitry components as described above with reference to FIGS. 2-3. In some embodiments, the quantum system arrangement 400 may include a classical communication channel 404 communicably coupling the first DPU 106 and the second DPU 206. As described above, the DPUs 106, 206 of the present disclosure may operate to perform preprocessing steps (e.g., error correction, synchronization, or the like) local to the respective quantum device 100, 200. In order to enable direct communication between the quantum devices 100, 200, in some embodiments, the first DPU 106 and the second DPU 206 may be communicably coupled via a classical communication channel 404. By way of a non-limiting example, in some instances the measurements applied to the first quantum system 104 by the second weak measurement module 202 may be dependent upon the measurements applied and/or information obtained by the first weak measurement module 102. As such, the first DPU 106 may generate a transmission based upon these measurements and/or information from the first weak measurement module 102 and provide this transmission via the classical communication channel 404 to the second DPU 206. The present disclosure contemplates that any mechanism or channel used for establishing communication between the quantum devices 100, 200 may be used by the quantum system arrangement 400 based upon its intended application.

The quantum system arrangement 400 may also include the first central control unit 103. As described above with reference to FIG. 1, the first central control unit 103 may be any classical device configured to process, analyze, etc. the data provided from quantum devices. As such, the first quantum device 100 may be communicably coupled with the first central control unit 103 via a classical communication channel 101, and the second quantum device 200 may be communicably coupled with the first central control unit 103 via a classical communication channel 201. In operation, the DPUs 106, 206 may be configured to generate and provide transmissions (e.g., data packets or the like) to the central control unit 103 via the classical communication channels 101, 201. Although the quantum system arrangement 400 in FIG. 4 is illustrated and described with reference to the first and second quantum devices 100, 200 measuring the first quantum system 104, the present disclosure contemplates that any number of quantum devices at any configuration may be used to alone or collectively measure the first quantum system 104.

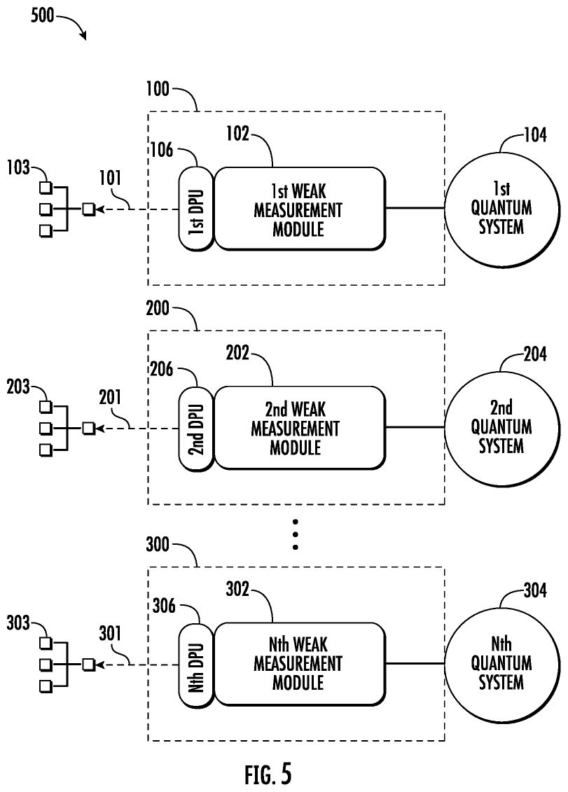

With reference to FIG. 5, an example quantum system arrangement 500 is illustrated. As shown, the quantum system arrangement 500 may include a plurality of quantum systems, where each of which are coupled to respective quantum devices. In particular, the first quantum device 100 having a first weak measurement module 102 and a first DPU 106 may be coupled with a first quantum system 104 and a first central control unit 103. A second quantum device 200 having a second weak measurement module 202 and a second DPU 206 may be coupled with a second quantum system 204 and a second central control unit 203 (e.g., via classical channel 201). An N^{th} quantum device 300 having an N^{th} weak measurement module 302 and an N^{th} DPU 306 may be coupled with an N^{th} quantum system 304 and an N^{th} central control unit 303 (e.g., via classical channel 301). Each of the quantum devices 100, 200, 300 of the example quantum system arrangement 500 may perform the operations described above with reference to FIGS. 1-4 and may similarly employ the same devices, components, elements, etc. The present disclosure contemplates that the quantum system arrangement 500 may include any number of quantum devices and quantum systems based upon the intended application of the arrangement 500. Furthermore, the present disclosure contemplates that the quantum devices 100, 200, 300 of the quantum system arrangement 500 may be directly coupled (e.g., via quantum or classical communication channels) (not shown) similar to the quantum devices 100, 200 of FIG. 4.

Furthermore, although illustrated and described as distinct central control units 103, 203, 303, the present disclosure contemplates that these control units may further refer to the network associated with these control units. For example and as described above with reference to the first central control unit 103, the quantum devices 100, 200, 300 may be formed as part of a network of quantum devices that includes various computing devices (e.g., central control units 103, 203, 303, etc.) such that the transmissions (e.g., data packets or the like) generated by these quantum devices 100, 200, 300 may be provided to the larger network.

Many modifications and other embodiments of the present disclosure will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A quantum device comprising:
a weak measurement module operably coupled with a quantum system, wherein the weak measurement module is configured to:
apply one or more measurements to the quantum system; and
obtain information associated with the quantum system based on the one or more measurements.

2. The quantum device according to claim 1, wherein a strength of the one or more measurements by the weak measurement module is configured to prevent a wave function collapse associated with the quantum system.

3. The quantum device according to claim 1, further comprising a data processing unit (DPU) operably coupled with the weak measurement module and configured to perform one or more operations on the obtained information associated with the quantum system, wherein the one or more operations are performed local to the quantum device by the DPU.

4. The quantum device according to claim 3, wherein the one or more operations are associated with one or more synchronization operations.

5. The quantum device according to claim 3, wherein the one or more operations are associated with one or more error correction operations.

6. The quantum device according to claim 3, wherein the DPU is operably coupled with a classical communication channel.

7. The quantum device according to claim 4, wherein the DPU is configured to generate transmissions to a central control unit and associated network operably coupled with the quantum device via the classical communication channel.

8. The quantum device according to claim 4, wherein the DPU is configured to generate transmissions to another quantum device operably coupled with the quantum device via the classical communication channel.

9. The quantum device according to claim 1, wherein the weak measurement module is operably coupled with another quantum device via a quantum communication channel.

10. The quantum device according to claim 9, wherein the another quantum device is configured to apply one or more measurements to the quantum system.

11. A distributed quantum system comprising:
a central control unit;
a first quantum device comprising:
a first weak measurement module operably coupled with a quantum system,
wherein the first weak measurement module is configured to:
apply one or more first measurements to the quantum system; and
obtain information associated with the quantum system based on the one or more first measurements.

12. The distributed quantum system according to claim 11, wherein a strength of the one or more first measurements by the first weak measurement module is configured to prevent a wave function collapse associated with the quantum system.

13. The quantum device according to claim 11, further comprising a first data processing unit (DPU) operably coupled with the first weak measurement module and configured to perform one or more operations on the obtained information associated with the quantum system, wherein the one or more operations are performed local to the first quantum device by the first DPU.

14. The distributed quantum system according to claim 13, wherein the one or more operations are associated with one or more synchronization operations.

15. The distributed quantum system according to claim 13, wherein the one or more operations are associated with one or more error correction operations.

16. The distributed quantum system according to claim 13, further comprising a classical communication channel.

17. The distributed quantum system according to claim 16, wherein the first DPU is operably coupled with the central control unit and associated network via the classical communication channel.

18. The distributed quantum system according to claim 13, further comprising:
a second quantum device comprising:
a second weak measurement module operably coupled with the quantum system,
wherein the second weak measurement module is configured to:
apply one or more second measurements to the quantum system; and
obtain information associated with the quantum system based on the one or more second measurements.

19. The distributed quantum system according to claim 18, further comprising a second DPU operably coupled with the second weak measurement module and configured to perform one or more operations on the obtained information associated with the quantum system, wherein the one or more operations are performed local to the second quantum device by the second DPU.

20. The distributed quantum system according to claim 18, further comprising a quantum channel, wherein the first weak measurement module and the second weak measurement module are communicably coupled via the quantum channel.
